(19) United States
(12) Patent Application Publication
(10) Pub. No.: US 2017/0040086 A1
(43) Pub. Date: Feb. 9, 2017

(54) INSULATED WIRE

(71) Applicant: HITACHI METALS, LTD., Tokyo (JP)

(72) Inventor: Masanobu NAKAHASHI, Tokyo (JP)

(21) Appl. No.: 15/221,437

(22) Filed: Jul. 27, 2016

(30) Foreign Application Priority Data
Aug. 3, 2015 (JP) 2015-153243
Aug. 3, 2015 (JP) 2015-153244

(51) Int. Cl. H01B 7/295; C09D 123/08; C09D 123/14; C09D 7/12; H01B 3/30; C09D 127/18

(52) U.S. Cl. CPC H01B 7/295; H01B 3/308; C09D 127/18; C09D 123/147; C09D 7/1216; C09D 123/0892; C08K 3/36

(57) ABSTRACT

There is provided an insulaled wire, comprising: a conductor; and
an insulated coating layer provided on an outer circumference of the conductor, wherein the insulated coating layer is made of a fluorine-containing elastomer composition containing a base polymer containing tetrafluoroethylene-α-olefin copolymer in which tetrafluoroethylene and α-olefin having 2 to 4 carbon atoms are polymerized, and having low smoke emission in which a target value of an optical density at the time of performing a smoke emission test based on a test method BS6853 is A0 (ON) or less represented by the following formula (1), and A0 (OFF) or less represented by the following formula (2), when an outer diameterof the insulated wire is defined as d [mm],

A0(ON)={(tan⁻¹(d/45)×180/π)/45}−{(tan⁻¹(d)×180/π)/2025} (1)

A0(OFF)=1.5×A0(ON) (2); and
low toxicity in which toxic gas total index is 1.0 or less when a toxicity test is performed based on a test method NFX-70-100.

### BACKGROUND

The present application is based on Japanese Patent Applications No. 2015-153243 and 2015-153244 filed on Aug. 3, 2015, the entire contents of which are hereby incorporated by reference.

### TECHNICAL FIELD

The present invention relates to an insulated wire.

An insulated wire is configured to include an insulated coating layer on an outer circumference of a conductor, and is used for example as a wiring of a railway vehicle, etc.

Not only excellent mechanical properties but also excellent flame retardancy, low smoke emission in which generation of smoke is small, and low toxicity in which a toxic gas generated by combustion is small from a viewpoint of safety in case of fire in the railway vehicle, are requested for the insulated coating layer of the insulated wire used for the railway vehicle. Further, an environment temperature at which the insulated wire is used, is likely to be high with a higher performance of the railway vehicle, and therefore it is demanded that the insulated wire is hardly deteriorated even when it is left for a long period of time under high temperature environment, and has excellent heat resistance.

Therefore, conventionally a silicone rubber composition is used as a material for forming the insulated coating layer (for example see patent document 1).
Patent document 1: Japanese Patent Laid Open Publication No.2013-129740

Incidentally, in recent years, high fire safety such as to pass fire safety standards (for example, EN standard and BS standard such as BS6853) overseas, is requested for the insulated wire, from a viewpoint of enhancing the safety at the time of fire. Further, higher mechanical properties and heat resistance are requested.

However, in the silicone rubber composition as shown in patent document 1, it is difficult to obtain well-balanced fire safety, mechanical properties, and heat resistance.

Therefore, in order to solve the above-described problem, an object of the present invention is to provide the insulated wire having excellent mechanical properties, heat resistance, and flame retardancy, and having low smoke emission and low toxicity.

### SUMMARY OF THE INVENTION

According to an aspect of the present invention, there is provided an insulated wire; including:

a conductor; and

an insulated coating layer provided on an outer circumference of the conductor,

wherein the insulated coating layer is made of a fluorine-containing elastomer composition containing a base polymer containing ietrafiuoroethyiene-α-olefin copolymer in which tetrafluoroethylene and α-olefin having 2 to 4 carbon atoms are polymerized, and having:

flame retardancy in which a char length is 2.5 m or less when a vertical tray combustion test is performed based on a test method BS EN60332-3;

low smoke emission in which a target value of an optical density at the time of performing a smoke emission test based on a test method BS6853 is A0 (ON) or less represented by the following formula (1), and A0 (OFF) or less represented by the following formula (2), when an outer diameter of the insulated wire is defined as d [mm],

A0(ON)={(tan⁻¹(d/45)×180/π)/45}−{(tan⁻¹(d)×180/π)/2025} (1)

A0(OFF)=1.5×A0(ON) (2); and

low toxicity in which toxic gas total index is 1.0 or less when a toxicity test is performed based on a Lest method NFX-70-100.

### BRIEF DESCRIPTION OF THE DRAWINGS

FIG. 1 is a cross-sectional view of the insulated wire according to an embodiment of the present invention.

### DETAILED DESCRIPTION OF THE INVENTION

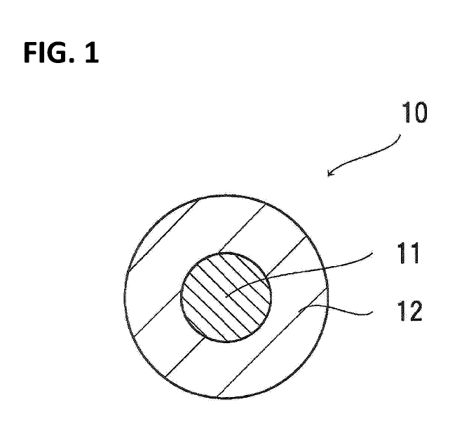

An insulated wire according to an embodiment of the present invention will be described hereafter using FIG. 1. FIG. 1 is a cross-sectional view of the insulated wire according to an embodiment of the present invention.

As shown in FIG. 1, the insulated wire 10 is configured to include a conductor 11 and an insulated coating layer 12 provided on an outer circumference of the conductor 11.

As the conductor 11, a usually used metal wire such as an aluminum wire, a gold wire, and a silver wire can be used other than a copper and a copper alloy wire. Also, it is also acceptable to use the metal wire obtained by applying metal-plating such as tin or nickel to the outer circumference of the metal wire. Further, a cluster conductor in which metal wires are twisted, can also be used.

The insulated coating layer 12 is provided so as to coat the outer circumference of the conductor 11, and is made of a fluorine-containing elastomer composition described later. The insulated coating layer 12 is formed by extrusion-molding the fluorine-containing elastomer composition so as to coat the outer circumference of the conductor 11, and crosslinking the same.

The fluorine-containing elastomer composition of this embodiment has excellent flame retardancy, low smoke emission, and low toxicity, and therefore the insulated coating layer 12 made of the fluorine-containing elastomer composition has high fire safety.

Specifically, the insulated coating layer 12 has high flame retardancy in which a char length is 2.5 m or less when a vertical tray combustion test is performed based on a test method BS EN60332-3, and also the insulated coating layer 12 has high flame retardancy to satisfy standard EN45545-2, in which the distance from the upper end to the upper carbide part of the insulated wire 1 is 50 mm or more and the distance form the upper end to the lower carbide part is less than 540 mm when a vertical combustion test is performed for the insulted wire 1 based on a test method BS EN60332-1-2. The insulated coating layer 12 also has a low smoke emission in which a target value of an optical density al the time of performing a smoke emission test based on a test method BS6853 is A0 (ON) or less represented by the following formula (1), and A0 (OFF) represented by the following formula (2), when an outer diameter of the insulated wire is defined as d [mm]:

A0(ON)={tan⁻¹(d/45)×180/π/45}−{(tan⁻¹(d)×180/π)/2025} (1)

A0(OFF)=1.5×A0(ON) (2).

and low toxicity in which toxic gas total index is 1.0 or less when a toxicity test is performed based on a test method NFX-70-100, and such as to satisfy standard BS6853.

Further, since the fluorine-containing elastomer composition has excellent mechanical properties and heat resistance, the insulated coating layer 12 has excellent mechanical properties in an initial state (before deterioration) and is hardly deteriorated even if it is left over a long period of time under high temperature environment, and can maintain high mechanical properties. Specifically, the insulated coating layer 12 has high mechanical properties in which a tensile strength is 15 MPa or more and an elongation is 200% or more in the initial state, and high heat resistance in which reduction of the mechanical properties due to deterioration by heating is small even after being left for four days under high temperature environment of 250° C., and tensile strength retention and elongation retention are both 80% or more.

Here, the fluorine-containing elastomer composition forming the insulated coating layer 12 will be specifically described.

The fluorine-containing elastomer composition contains a base polymer containing at least one kind of tetrafluoroethylene-α-olefin copolymer obtained by polymerizing tetrafluoroethylene and α-olefin having 2 to 4 carbon atoms. The tetrafluoroethylene-α-olefin copolymer has tetrafluoroethylene and α-olefin, and contains a fluorine atom derived from tetrafluoroethylene in a chemical structure. Therefore, the fluorine-containing elastomer composition has excellent flame retardancy and heat resistance, and has small smoke emission and small toxic gas generation when being combusted.

Although a fluorine content in the base polymer is not particularly limited, large content is preferable from a viewpoint of the flame retardancy and the heat resistance of the insulated coating layer 12. Specifically, 55 mass % or more is preferable, and 57 mass % or more is more preferable. On the other hand, when the fluorine content is excessive, a balance of the tensile strength and the elongation of the insulated coating layer 12 is lost, and there is a possibility of reducing the mechanical properties. Therefore 65 mass % or less is preferable, and 63 mass % or less is more preferable. Namely, by setting the fluorine content to 55 mass % to 65 mass % and more preferably 57 mass % to 63 mass %, the flame retardancy and the heat resistance can be improved while maintaining the high mechanical properties of the insulated coating layer 12.

In this specification, the fluorine content of the base polymer is represented by x×y, when the fluorine content (mass %) of the tetrafluoroethylene-α-olefin copolymer is defined as x, and the rate of this copolymer to the base polymer is defined as y. Also, when two kinds or more are used for the base polymer as the tetrafluoroethylene-α-olefin copolymer, x and y are respectively obtained and by summing them, the fluorine content of the base polymer is calculated.

The olefin having 2 to 4 carbon atoms is not particularly limited, as long as it exhibits elastomeric properties by copolymerizing with tetrafluoroethylene, and for example at least one kind selected from ethylene, propylene, butane-1 and isobutene can be used. From a viewpoint of obtaining the high flame retardancy and the heat resistance in the insulated coating layer 12, the base polymer preferably contains at least tetrafluoroethylene-propylene-based copolymer (also referred to as “TFEP copolymer” hereafter) as the tetrafluoroethylene-α-olefin copolymer. Further, as described later, from a viewpoint of adjusting the fluorine content in the base polymer, the base polymer further preferably contains ethylene-tetrafluoroethylene-based copolymer (also referred to as “ETFE copolymer” hereafter) as the tetrafluoroethylene-α-olefin copolymer in addition to the TFEP copolymer.

The TFEP copolymer may be mainly made of tetrafluoroethylene and propylene, but also a third component copolymerizable with them may be suitably polymerized. As the copolymerized third component, for example, ethylene, isobutylene, acrylic acid and its alkyl ester, vinyl fluoride, vinylidene fluoride, hexafluoropropene, chloroethyl vinyl ether, chlorotrifluoroethylene, perfluoroalkyl and vinyl ether, etc., can be given. In the TFEP copolymer, the molar ratio of the tetrafluoroethylene and polypropylene is not particularly limited, but from the viewpoint of flame retardancy and heat resistance, the molar ratio of the tetrafluoroethylene is preferably set to be large so that the fluorine content becomes large.

The ETFE copolymer is a compound having a large fluorine content compared to the TFEP copolymer. The fluorine content of the base polymer can be increased by mixing the ETFE copolymer into the TFEP copolymer in the base polymer. Thus, the heat resistance and the flame retardancy of the insulated coating layer 12 can be further improved. Also, the ETFE copolymer has a high crystallinity and therefore the mechanical properties (tensile strength) of the insulated coating layer 12 can be improved.

The ETFE copolymer may be mainly made of tetrafluoroethylene and ethylene, but fluoroolefin may also be polymerized as a third component. As the fluoroolefin, for example chlorotrifluoroethylene, vinylidene fluoride, trifluoroethylene, 1,1-dihydro perfluoropropene, 1,1-dihydro-perfluoro butene 1, 1,5-trihydrofluoride perfluoroalkyl penten-1, 1,1,7-trihydrofluoride perfluoroalkyl pentene-1, 1,1,2-trihydrofluoride perfluoroalkyl hexene-1, 1,1,2-trihydrofluoride perfluoroalkyl octene-1, perfluoro (methyl vinyl ether), perfluoro (ethyl vinyl ether), hexafluoropropane, perfluoro-butene-1,3, 3,3-trifluoro-2-trifluoromethyl propene-1, etc., can be given. They may be used alone, of may be used in combination of two or more kinds thereof. Also, in the ETFE copolymer, the molar ratio of tetrafluoroethylene and ethylene is not particularly limited, but from the viewpoint of the flame retardancy and the heat resistance, the molar ratio of the tetrafluoroethylene is preferably set to be large so that the fluorine content becomes large.

In the base polymer the mixing rate of the TFEP copolymer and the ETFE copolymer is not particularly limited, and for example may be set to the, ratio such that the fluorine content in the base polymer s 55 mass % to 65 mass %. When the mixing rate of the ETFE copolymer becomes excessively large, the fluorine content in the base polymer becomes large, and therefore there is a possibility that elongation properties (flexibility) are impaired, although the tensile strength of the insulated coating layer 12 is increased. Therefore, from the viewpoint of maintaining the well-balanced tensile strength and the elongation properties, the mixing rate of the TFEP copolymer and the ETFE copolymer is preferably set in a range of 50:50 to 100:0, and further preferably set in a range of 60:40 to 80:20.

An average molecular weight of the numbers (number average molecular weight) of the tetrafluoroethylene-α-olefin copolymer is not particularly limited, but when it is too low, there is a possibility that the mechanical properties of the insulated coating layer 12 is reduced, and therefore 20,000 or more is preferable. On the other hand, when the number average molecular weight is too high, extrusion-moldability of the fluorine-containing elastomer composition is reduced, and there is a possibility that cracks are generated in the insulated coating layer 12, and therefore 200,000 or less is preferable. Namely, by setting the average molecular weight of the numbers in a range of 20,000 to 200,000, generation of the cracks can be suppressed and the mechanical properties can be improved in the insulated coating layer 12. Adjustment of the number average molecular weight can be performed by a method of directly adjusting the generated polymer by manupilating copolymerization reaction conditions such as a monomer concentration, polymerization initiator concentration, monomer-to-polymerization initiator amount ratio, polymerization temperature, and use of a chain transfer agent, etc., or by a method of obtaining a low molecular weight by generating a high molecular weight copolymer during copolymerization reaction and applying heat treatment thereto under presence of oxygen.

A filler may be blended into the fluorine-containing elastomer composition, from a viewpoint of improving the mechanical properties of the insulated coating layer 12. An inorganic filler is preferable as the filler, and for example silica, anhydrous silicic acid, magnesium silicate, aluminum silicate calcium carbonate or the like can be used. Among them, silica is particularly preferable. Silica can improve the mechanical properties of the insulated coating layer 12, and also can suppress the combustion by forming a carbide layer on the surface of the insulated coating layer 12 during combustion of the insulated coating layer 12, and can improve the flame retardancy of the insulated coating layer 12.

A blending quantity of the filler is not particularly limited, and 30 pts.mass or less based on 100 pts.mass of the base polymer is preferable, because if the blending quantity is excessively large, there is a possibility that the mechanical properties and the heat resistance of the insulated coating layer 12 are impaired. Also, 5 pts.mass or more based on 100 pts.mass of the base polymer is preferable from a viewpoint of obtaining a desired mechanical property in the insulated coating layer 12. Namely, by blending 5 pts.mass or more and 30 pts.mass or less of the filler, the mechanical properties can be improved without impairing the heat resistance of the insulated coating layer 12.

Further, upon crosslinking, a crosslinking agent of a crosslinking aid may be blended into the fluorine-containing elastomer composition. As a crosslinking method, there is a chemical crosslinking in which for crosslinking, the crosslinking agent (organic peroxides or amines, etc.) is added to the fluorine-containing elastomer composition and a heat treatment is applied thereto, and there is a radiation crosslinking in which for crosslinking, the crosslinking aid is added to the fluorine-containing elastomer composition and ionizing radiation such as γ-rays or electron rays is applied thereto. For the chemical crosslinking, it is preferable to use an organic peroxide as the crosslinking agent from a viewpoint of suppressing a residual ionic impurities after crosslinking, and for example peroxy ketal, hydroperoxides, dialkyl peroxides, diacyl peroxides, peroxy esters, and a peroxydicarbonate, etc., may be used. Among them, dialkyl peroxides are particularly preferable from a viewpoint of reactivity. For the radiation crosslinking, the crosslinking aid may be blended, and for example an allylic compound such as triallyl isocyanurate, triallyl cyanurate, triallyl trimellitate, and tetra allyl pyromellitate, etc., may be used. They may be used alone, or may be used in combination of two or more thereof.

Further, other inorganic fillers, stabilizers, antioxidants, plasticizers, or lubricants, etc., may be blended into the fluorine-containing elastomer composition as needed. They may be blended in a range of not impairing the properties of the fluorine-containing elastomer composition.

The fluorine-containing elastomer composition can be obtained by kneading the abovementioned components.

### EXAMPLES

The present invention will be described next in further detail based on examples. However, the present invention is not limited to these examples.

Raw materials used in examples and comparative examples are as follows.
Tetrafluoroethylene—propylene copolymer (fluorine content: 57 mass %)
Ethylene—tetrafluoroethylene copolymer (fluorine content: 68 mass %)
Filler: silica, surface-treated calcium carbonate
Crosslinking agent: Organic peroxide
Crosslinking agent: Allyl-type compound

### (1) Production of the Insulated Wire

### Example 1

First, as shown in the following table 1, a fluorine-containing resin composition was prepared by using 100 pts.mass of tetrafluoroethylene-propylene as the base polymer, and adding 15 pts.mass of silica, 2 pts.mass of organic peroxide and 5 pts.mass of allylic compound to the base polymer, and kneading them in a roll. The fluorine content in this base polymer was 57 mass %.

Subsequently, the prepared fluorine-containing resin composition was extruded with a thickness of about 1.6 mm on an outer circumference of a conductor (tin-plated copper twisted wire) having an outer diameter of 10.2 mm, using 90 mm extruder. Thereafter, steam crosslinking was performed for 3 minutes at 13 atmospheric pressure, to thereby form an insulated coating layer and produce the insulated wire of example 1 having an outer diameter of 13.5 mm. In the 90 mm extruder, a cylinder temperature was set to 80° C., a head temperature was set to 90° C., and a die temperature was set to 100° C. respectively.

### Examples 2 to 4

In examples 2 to 4, the fluorine-containing resin composition was prepared by mixing tetrafluoroethylene-propylene copolymer and ethylene-tetrafluoroethylene copolymer in the rate shown in the following table 1 to obtain the base polymer, then adding 15 pts.mass of silica and 5 pts.mass of allylic compound to the base polymer, and kneading them. The fluorine content in the base polymer was set to 59.2 mass % in example 2, 61.4 mass % in example 3, and 62.5 mass % in example 4.

Subsequently, the fluorine-containing resin composition of examples 2 to 4 was extruded with a thickness of about 1.6 mm on the outer circumference of the tin-plated copper twisted wire having an outer diameter of 10.2 mm, using 90 mm extruder. Thereafter, the insulated wire of examples 2 to 4 having an outer diameter of 13.5 mm was produced by crosslinking the fluorine-containing resin composition by irradiating it with an electron beam of 10 Mrad, and forming the insulated coating layer. In the 90 mm extruder, the cylinder temperature was set to 200 to 260°C., the head temperature was set to 270° C., and the die temperature was set to 280° C. respectively.

### Comparative Example 1

In comparative example 1, the insulated wire was produced by preparing the fluorine-containing resin composition similarly to example 2, other than a point that the mixing rate of tetrafluoroethylene-propylene copolymer and ethylene-tetrafluoroethylene copolymer in the base polymer was set to 30:70. In comparative example 1, the fluorine content in the base polymer was 64.7 mass %.

### Comparative Examples 2 and 3

In comparative examples 2 and 3, the insulated wire was produced by preparing the fluorine-containing resin composition similarly to example 2, other than a point that the blending quantity of silica was changed to 2 pts.mass and 40 pts.mass respectively.

### Comparative Example 4

In comparative example 4, the insulated wire was produced by preparing the fluorine-containing resin composition similarly to example 2, other than a point that the mixing rate of tetrafluoroethylene-propylene copolymer and ethylene-tetrafluoroethylene copolymer was set to 90:10, and 60 pts.mass of surface-treated calcium carbonate was added as the filler instead of silica.

### Comparative Example 5

In comparative example 5, the insulated wire was produced similarly to example 1, other than a point that a silicone rubber composition was used instead of the fluorine-containing resin composition. The silicone rubber composition was prepared by adding 2 pts.mass of organic peroxide to 100 pts.mass of silicone rubber.

TABLE 1

| | | | | Example | | | | Comparative example | | | | |
|---|---|---|---|---|---|---|---|---|---|---|---|---|
| | | | | 1 | 2 | 3 | 4 | 1 | 2 | 3 | 4 | 5 |
| Compo- | Polymer | | Tetrafluoroethylene-propylene copolymer | 100 | 80 | 60 | 50 | 30 | 80 | 80 | 90 | — |
| sition | | | (fluorine content: 57 mass %) | | | | | | | | | |
| | | | Ethylene-tetrafluoroethylene copolymer | — | 20 | 40 | 50 | 70 | 20 | 20 | 10 | — |
| | | | (fluorine content: 68 mass %) | | | | | | | | | |
| | | | Silicone rubber | — | — | — | — | — | — | — | — | 100 |
| | Filler | | Silica | 15 | 15 | 15 | 15 | 15 | 2 | 40 | — | — |
| | | | Surface-treated calcium carbonate | — | — | — | — | — | — | — | 60 | — |
| | Crosslinking agent | | Organic peroxide | 2 | — | — | — | — | — | — | — | 2 |
| | Crosslinking aid | | Allylic compound | 5 | 5 | 5 | 5 | 5 | 5 | 5 | 5 | — |
| | Fluorine content in base polymer (mass %) | | | 57 | 59.2 | 61.4 | 62.5 | 64.7 | 59.2 | 59.2 | 58.1 | 0 |
| Prop- | Mechanical properties | | Tensile strength (Mpa): 15 or more | 16.2 | 19.5 | 21.4 | 23.5 | 26.1 | 13.3 | 17.3 | 13.5 | 13.2 |
| erties | | | Elongation (%): Target 200 or more | 400 | 280 | 240 | 220 | 110 | 320 | 130 | 250 | 460 |
| | Heat | 250° C. | Tensile strength retention (%): Target | 110 | 115 | 115 | 118 | 98 | 110 | 108 | 90 | — |
| | resistance | after 96 h | 80 or more | | | | | | | | | |
| | | | Elongation retention (%): Target 80 or more | 95 | 98 | 100 | 99 | 120 | 104 | 68 | 86 | — |
| | | 220° C. | Tensile strength retention (%): Target 80 | — | — | — | — | — | — | — | — | 74 |
| | | after 96 h | or more | | | | | | | | | |
| | | | Elongation retention (%): Target 80 or more. | — | — | — | — | — | — | — | — | 71 |
| | Fire Safety | Flame | Vertical tray combustion test: Target | ∘ | ∘ | ∘ | ∘ | ∘ | ∘ | ∘ | ∘ | x |
| | | retardancy | Char length is 2.5 m or less | | | | | | | | | |
| | | | Vertical tray combustion test: Target | ∘ | ∘ | ∘ | ∘ | ∘ | ∘ | ∘ | ∘ | x |
| | | | distance from the upper end to the upper | | | | | | | | | |
| | | | carbide part of the insulated wire is 50 mm | | | | | | | | | |
| | | | or less and the distance from the upper end | | | | | | | | | |
| | | | to the lower carbide part is less than 540 mm | | | | | | | | | |
| | | Smoke | Smoke emission test: Target value of optical | ∘ | ∘ | ∘ | ∘ | ∘ | ∘ | ∘ | ∘ | x |
| | | emission | density is A0(ON) or less and A0(OFF) or less | | | | | | | | | |
| | | Toxicity | Toxicity test: Target, toxic gas total index | ∘ | ∘ | ∘ | ∘ | ∘ | ∘ | ∘ | ∘ | ∘ |
| | | | is 1.0 or less | | | | | | | | | |

### (2.) Evaluation Method

The produced insulated wire was evaluated by the following method.

### (Mechanical Properties)

The mechanical properties of the insulated coating layer were evaluated using a tube-shaped insulated coating layer obtained by extracting a conductor from the insulated wire. Specifically, an initial tensile property (tensile strength and elongation) of the tube-shaped insulated coating layer was measured. In this example, a target tensile strength was set to 15 Mpa or more and a target elongation was set to 200% or more.

### (Heat Resistance)

The heat resistance of the insulated coating layer was evaluated by aging (deteriorating) the tube-shaped insulated coating layer by heating, the insulated coating layer being obtained by extracting the conductor from the insulated wire. Specifically, the tube-shaped insulated coating layer was put into a heat aging tester and deteriorated by heating under prescribed aging conditions (temperature, time), and thereafter the tensile properties (tensile strength and elongation) after heat aging were measured. The aging conditions were 4 days at 250° C. in the example, and 4 days at 220° C. in the comparative example. Then, as shown in the following formula, the retention of the tensile properties (tensile strength retention (%) and elongation retention (%)) after heat aging with respect to the initial tensile properties, were calculated. In this example, in both of the tensile strength retention (%) and the elongation retention (%), a target retention was 80% or more. When these retentions are less than 80%, the insulated coating layer was excessively deteriorated by heating, and the heat resistance becomes insufficient.

Tensile strength retention (%)=(Tensile strength after test/tensile strength before test)×100

Elongation retention (%)=(Elongation after test/elongation before test)×100

### (Flame Retardancy)

The flame retardancy of the insulated coating layer was evaluated by the following two methods.

One of them is the method of evaluating the flame retardancy from the char length defined by standard BS6853 by performing the vertical tray combustion test based on the test method BS EN60332-3. Specifically, seven insulated wires having a full length of 3.5 m were twisted in one bundle, and eleven bundles were arranged at equal intervals, and one end of each bundle was burned for 20 minutes. Then, after self-extinguishing, a carbonized length (char length) of the insulated coating layer was measured. In this example, it is so judged that the insulated coating layer had excellent flame retardancy when the char length was 2.5 m or less.

The other method is the method of evaluating the flame retardancy of the insulated coating layer, in which whether not satisfying the standard EN45545-2 was evaluated by performing the vertical combustion test based on the test method EN60332-1-2. Specifically, the insulated wire having a full length of 600 mm was vertically disposed, and its upper end and lower end were fixed to a supporting member, and flame was added on a position of 475 mm from the upper end of the vertically fixed insulated wire for a prescribed time, and a carbide state of the insulated coating layer after self-extinguishing was observed. In this example, distance d₁ from the upper end to an upper carbide part of the insulated wire, and distance d₂ from a wire upper end to a lower carbide part of the insulated wire were measured, and it was so judged that the insulated wire had excellent flame retardancy when distance d₁ was 50 mm or more, and distance d₂ was less than 540 mm. The upper end of the insulated wire shows a lower end of an upper side supporting member that fixes the upper end of the insulated wire. The upper carbide part shows an endpoint of the carbide that spreads upward by adding flame to a middle of the vertically fixed insulated wire, and the lower carbide part shows an endpoint of the carbide that spreads downward of the insulated wire.

### (Smoke Emission)

The smoke emission of the insulated coating layer was evaluated by performing the smoke emission test based on the test method BS6853. Specifically, in a 3 m cubic test chamber, four insulated wires were burned using an alcohol fuel. Then, the smoke emission of the insulated coating layer was evaluated from an attenuation amount of attenuating a light transmittance in the test chamber due to a smoke generated by burning the insulated coating layer. As the attenuation amount of the light transmittance is smaller, the concentration of the smoke in the test chamber is small, thus showing that a generation amount of the smoke is small when the insulted wire is burned. In this example, when the target value of the optical density is A0 (ON) or less represented by the following formula (1) and A0 (OFF) represented by the following formula (2) when the outer diameter of the insulated wire is defined as d [mm], the smoke emission satisfies the standard BS6853, and it was evaluated that attenuation of the light transmittance was small with low smoke emission. The optical density A0 (ON) shows the optical density when the insulated wire is fired, and the optical density A0 (OFF) shows the optical density when the fire is burned out.

A0(ON)={(tan⁻¹(d/45)×180/π)/45}−{(tan⁻¹(d)×180/π)/2025} (1)

A0(OFF)=1.5×A0(ON) (2)

### (Toxicity)

The toxicity of the insulated coating layer was evaluated by performing a combustion test based on the test method NFX70-100 and by the toxic gas total index which is the index of the generation amount of the toxic gas at this time. Specifically, first, a test piece of 1 g was taken from the insulated coating layer, then the test piece was burned at a prescribed temperature, and toxic gases (CO, CO₂, HCl, HBr, HCN, HF, SO₂ and NOx) generated from the test piece were recovered. Then, each gas was quantitatively analyzed, to calculate a gas index of each gas by dividing a measured value of each gas by a defined critical concentration. Then, the toxic gas total index was obtained by summing these gas indexes. As the toxic gas total index is smaller, the generation amount of the toxic gas is small, with low toxicity. In this example, when the toxic gas total index was I or less, this is judged to be acceptable.

### (3) Evaluation Result

In examples 1 to 4, it was confirmed that the insulated coating layer had excellent mechanical properties and heat resistance. It was also confirmed that the insulated coating layer had an excellent fire safety with high flame retardancy, low emission smoke, and low toxicity.

In contrast, in comparative example 1, the mixing rate of the ethylene-tetrafluoroethylene copolymer was large compared to examples 1 to 4, and the fluorine content in the base polymer becomes large. Therefore, although the tensile strength was as high as 26.1 Mpa, the elongation was as small as 110%, and the mechanical properties were insufficient.

In comparative example 2, the blending quantity of silica as the filler, was small compared to examples 1 to 4, and therefore the tensile strength was as low as 13.3 Mpa. In contrast, in comparative example 3, the blending quantity of silica was excessively large, and therefore it was confirmed that the elongation was as low as 130%, and the mechanical properties were poor, and in addition, the elongation retention after 6 hours at 250° C. was as low as 68%, and the heat resistance was poor

In comparative example 4, a large quantity of surface-treated calcium carbonate was used instead of silica, and therefore it was confirmed that the tensile strength was as low as 13.5 Mpa, and the mechanical properties were poor.

In comparative example 5, the insulated coating layer was formed by the silicone rubber composition, and therefore it was confirmed that the insulated coating layer had poor heat resistance and also had poor flame retardancy and smoke emission, thus not satisfying the fire safety shown in standard BS6853.

### <Preferable Aspect of the Present Invention>

Preferable aspects of the present invention will be described hereafter.

### [Supplementary Description 1]

According to an aspect of the present invention, there is provided an insulated wire, including:

a conductor; and

an insulated coating layer provided on an outer circumference of the conductor,

wherein the insulated coating layer is made of a fluorine-containing elastomer composition containing a base polymer containing tetrafluoroethylene-α-olefin copolymer in which tetrafluoroethylene and having 2 to 4 carbon atoms are polymerized, and having:

low smoke emission in which a target value of an optical density at the time of performing a smoke emission test based on a test method BS6853 is A0(ON) or less represented by the following formula (1), and A0(OFF) or less represented by the following formula (2), when an outer diameter of the insulated wire is defined as d [mm],

A0(ON)={(tan⁻¹(d/45)×180/π)/45}−{(tan⁻¹(d)×180/π)/2025} (1)

A0(OFF)=1.5×A0(ON) (2); and

low toxicity in which toxic gas total index is 1.0 or less when a toxicity test is performed based on a test method NFX-70-100.

### [Supplementary Description 2]

There is provided the insulated wire of the supplementary description 1, having flame retardancy in which a char length is 2.5 m or less when a vertical tray combustion test is performed based on a test method BS EN60337-3.

### [Supplementary Description 3]

There is provided the insulated wire of the supplementary description 1 or 2, having flame retardancy in which the distance from the upper end to the upper carbide part of the insulated wire is 50 mm or more and the distance from the upper end to the lower carbide part is less than 540 mm when a vertical combustion test is performed for the insulted wire based on a test method EN60332-1-2.

### [Supplementary Description 4]

There is provided the insulated wire of the supplementary descriptions 1 to 3, wherein a fluorine content in the base polymer is 55 mass % or more and 65 mass % or less.

### [Supplementary Description 5]

There is provided the insulated wire of the supplementary descriptions 1 to 4, wherein the base polymer contains a tetrafluoroethylene-propylene-based copolymer and an ethylene-tetrafluoroethylene-based copolymer as the tetrafluoroethylene-α-olefin copolymer.

### [Supplementary Description 6]

There is provided the insulated wire of the supplementary description 5, wherein the base polymer contains the tetrafluoroethylene-propylene-based copolymer and the tetrafluoroethylene-based copolymer at a rate in a range of 50:50 to 100:0.

### [Supplementary Description 7]

There is provided the insulated wire of the supplementary descriptions 1 to 6, wherein the fluorine-containing elastomer composition further contains silica.

### [Supplementary Description 8]

There is provided the insulated wire of the supplementary description 7, wherein the fluorine-containing elastomer composition contains 5 pts.mass or more and 30 pts.mass or less of silica based on 100 pts.mass of the base polymer.

What is claimed is:

1. An insulated wire, comprising:
a conductor; and
an insulated coating layer provided on an outer circumference of the conductor,
wherein the insulated coating layer is made of a fluorine-containing elastomer composition containing a base polymer containing tetrafluoroethylene-α-olefin copolymer in which tetrafluoroethylene and α-olefin having 2 to 4 carbon atoms are polymerized, and having:
low smoke emission in which a target value of an optical density at the time of performing a smoke emission test based on a test method BS6853 is A0(ON) or less represented by the following formula (1), and A0(OFF) or less represented by the following formula (2), when an outer diameter of the insulated wire is defined as d [mm].
A0(ON)={(tan⁻¹(d/45)×180/π)/45}−{(tan⁻¹(d)×180/π)/2025} (1)
A0(OFF)=1.5×A0(ON) (2); and
low toxicity in which toxic gas total index is 1.0 or less when a toxicity test is performed based on a test method NFX-70-100.

2. The insulated wire according to claim 1, having flame retardancy in which a char length is 2.5 m or less when a vertical tray combustion test is performed based on a test method BS EN60332-3.

3. The insulated wire according to claim 1, having flame retardancy in which the distance from the upper end to the upper carbide part of the insulated wire is 50 mm or more and the distance from the upper end to the lower carbide part is less than 540 mm when a vertical combustion test is performed for the insulted wire based on a test method EN60332-1-2.

4. The insulated wire according to claim 1, wherein a fluorine content in the base polymer is 55 mass % or more and 65 mass % or less.

5. The insulated wire according to claim 1, wherein the base polymer contains a tetrafluoroethylene-propylene-based copolymer and an ethylene-tetrafluoroethylene-based copolymer as the tetrafluoroethylene-α-olefin copolymer.

6. The insulated wire according to claim 5, wherein the base polymer contains the tetrafluoroethylene-propylene-based copolymer and the tetrafluoroethylene-based copolymer at a rate in a range of 50:50 to 100:0.

7. The insulated wire according to claim 1, wherein the fluorine-containing elastomer composition further contains silica.

8. The insulated wire according to claim 7, wherein the fluorine-containing elastomer composition contains 5 pts.mass or more and 30 pts.mass or less of silica based on 100 pts.mass of the base polymer.
